(19) United States
(12) Patent Application Publication
(10) Pub. No.: US 2006/0125842 A1
(43) Pub. Date: Jun. 15, 2006

(54) Image interpolation device and method of preventing aliasing

(76) Inventors: Il-do Kim, Seoul (KR); Moon-cheol Kim, Suwon-si (KR); Dong-bum Choi, Suwon-si (KR)

Correspondence Address: STANZIONE & KIM, LLP, 919 18TH STREET, N.W., SUITE 440, WASHINGTON, DC, 20006, US

(21) Appl. No.: 11/270,659

(22) Filed: Nov. 10, 2005

(30) Foreign Application Priority Data
Dec. 10, 2004 (KR) 2004-104168

(51) Int. Cl. G09G 5/00

(52) U.S. Cl. 345/611

(57) ABSTRACT

An image interpolation device and method of preventing aliasing. The image interpolation device to prevent aliasing includes an aliased-region detection part to detect a region where aliasing occurs based on the magnitudes and signs of high-frequency components R_{H}, G_{H}, and B_{H} at pixels of n²-times-density R, G, and B images, and an anti-aliasing-processing part to perform an anti-aliasing operation on the detected aliased-region and to restore a captured image of an object from the n²-times-density RGB image having the detected aliased-region. The device can restore an image signal identical to an object image signal from a distorted signal that results from the aliasing. Therefore, the device can enhance the high-frequency components of an image without overshoots and undershoots, can reduce color errors, and can enhance color contrast.

### CROSS-REFERENCE TO RELATED APPLICATIONS

This application claims the benefit under 35 U.S.C. §119 of Korean Patent Application No. 2004-104168, filed on Dec. 10, 2004, the entire contents of which are incorporated herein by reference.

### BACKGROUND OF THE INVENTION

1. Field of the Invention

The present general inventive concept relates to an image interpolation device and method, and more particularly, to an image interpolation device and method to detect regions where aliasing occurs and to perform an anti-aliasing operation on the detected regions where aliasing occurs, thereby restoring an original image.

2. Description of the Related Art

Generally, an image signal is typically represented by three primary colors of light, red R, green G, and blue B, and otherwise, represented by a luminance signal Y and two types of color difference signals R-Y and B-Y The three primary RGB colors become input signals to a computer monitor in general, and the luminance signal Y and the color difference signals R-Y and B-Y become input forms in digital portions of devices such as TV families.

Hereinafter, a conventional 3-CCD pixel converter is described with reference to FIG. 1. FIG. 1 is a view schematically illustrating the conventional 3-CCD pixel optical converter as shown in Japanese Laid-opened Patent Publication No. Hei 14-095001. The conventional 3-CCD pixel converter includes a blue CCD DB, a red CCD DR, a green CCD DG, a blue prism 1, a red prism 2, a green prism 3, a blue trimming filter 4, a red trimming filter 5, and a green trimming filter 6. Referring to FIG. 1, the three CCDs (Charge Coupled Devices) convert R, G, and B images output from an optical wavelength splitter into electrical signals, and output the converted electrical signals. The conventional 3-CCD pixel optical converter is a device having the green CCD DG shifted in arrangement by ½ pixel in the vertical and horizontal directions from the red CCD DR and the blue CCD DB, respectively.

FIG. 2 is a view illustrating pixel locations of the red and the blue CCDs DR and DB and pixel locations of the green CCD DG of FIG. 1. The pixel location is represented by the (column number, row number). If data of the R, G, and B images converted into the electric signals by the conventional 3-CCD pixel optical converter is interpolated into images of four-times density as illustrated in FIG. 2, low-frequency image data is interpolated so that a low-frequency component Y_{L} of a luminance value of the luminance signal Y and the color difference signals ((R−Y), (B−Y)) are calculated using the expressions below.
G_{L}(33)={2G(31)+2G(35)+2G(13)+2G(53)}/8
G_{L}(43)={2G(31)+2G(51)+2G(35)+2G(55)+G(13)+G(73)+3G(33)+3G(53)}/16
G_{L}(34)={2G(33)+2G(35)+G(13)+G(15)+G(53)+G(55)}/8
G_{L}(44)={G(13)+7G(33)+7G(53)+G(73)+G(15)+7G(35)+7G(55)+G(75 )}/32
B_{L}(44)={2B(42)+2B(24)+2B(46)+2B(64)}/8
B_{L}(34)={2B(22)+2B(42)+2B(26)+2B(46)+B(04)+B(64)+3B(24 )+3B(24)+B(44)}/16
B_{L}(43)={2B(42)+2B(44)+B(22)+B(24)+B(62)+B(64)}/8
B_{L}(33)={B(02)+7B(22)+7B(42)+B(62)+B(04)+7B(24)+7B(44)+B(64)}/32
R_{L}(44)={2R(42)+2R(24)+2R(46)+2R(64)}/8
R_{L}(34)={2R(22)+2R(42)+2R(26)+2R(46)+R(04)+R(64)+3R(24)+3R(44)}/16
R_{L}(43)={2R(42)+2R(44)+R(22)+R(24)+R(62)+R(64)}/8
R_{L}(33)={R(02)+7R(22)+7R(42)+R(62)+R(04)+7R(24)+7R(44)+R(64)}/32
Y_{L}=0.71581875 G_{L}+0.2119125 R_{L}+0.0712875 B_{L}
R−Y=R_{L}−Y_{L}, B−Y=B_{L}−Y_{L}

Next, a high-frequency component Y_{H} of the luminance value of the luminance signal Y is calculated using the expressions below.
Y_{H}(33)={8G(33)−2G(31)−2G(35)−2G(13)−2G(53)}/8
Y_{H}(43)={2G(33)+2G(53)+2RB(42)+2RB(44)−G(31)−G(35)−G(51)−G(55)−RB(22)−RB(24)−RB(62)−RB(64)}/8
Y_{H}(34)={2G(33)+2G(35)+2RB(24)+2RB(44)−G(13)−G(15)−G(53)−G(55)−RB(22)−RB(26)−RB(42)−RB(46)}/8
Y_{H}(44)={8RB(44)−2RB(42)−2RB(46)−2RB(24)−2RB(64)}/8
Y=Y_{L}+Y_{H}

That is, the conventional 3-CCD pixel converter image-interpolates CCD-output data itself to calculate images of the low-frequency components, and uses correlations between the CCD-output data to calculate images of the high-frequency component.

In a conventional method as described above, the high-frequency components of the luminance value are calculated under the assumption that R, G, and B light have the same influence on the luminance value. However, in the method described above, there is a problem in that noise in the image increases. In addition, since the image data of the high-frequency components itself is added to the images of the low-frequency components, there is also a problem in that overshoots, undershoots, and color errors occur in edge regions of the image.

### SUMMARY OF THE INVENTION

The present general inventive concept provides an image interpolation device and method of enhancing high-frequency components of an image without overshoots and undershoots and enhancing image contrast by using an anti-aliasing image interpolation method.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an image interpolation device, comprising an aliased-region detection part to detect a region in which aliasing has occurred based on magnitudes and signs of high-frequency components R_{H}, G_{H}, and B_{H} at pixels of n²-times-density R, G, and B images, and an anti-aliasing-processing part to perform an anti-aliasing operation on the detected aliased-region and to restore an original image from the image having the aliased-region.

The device may further comprise an n²-times-density image interpolation part to interpolate an image captured by an image detector into the n²-times-density R, G, and B images and to calculate the high-frequency components R_{H}, G_{H}, and B_{H} and low-frequency components R_{L}, G_{L}, and B_{L} of the corresponding R, G, and B images, respectively.

The aliased-region detection part may further include a magnitude-judging unit to compare magnitudes of the high-frequency components R_{H}, G_{H}, and B_{H} at the pixels of the respective n²-times-density R, G, and B images, and to determine a high-frequency component having a larger magnitude at a current pixel, a sign-judging unit to set a maximum region if a sign of the high-frequency component having the larger magnitude among the high-frequency components R_{H}, G_{H}, and B_{H} of the n²-times-density RGB image is positive (+) at the current pixel, to set a minimum region if the sign of the high-frequency component having the larger magnitude is negative (−) at the current pixel, and to set a zero region if the signal of the high-frequency component having the larger magnitude is zero at the current pixel, and an aliased-region-judging unit to determine that the maximum and minimum regions are regions where aliasing has occurred and to determine that the zero region is a region where aliasing has not occurred.

The anti-aliasing-processing part may include a region-judging unit to determine whether the detected aliased-region is included in the minimum region or the maximum region, a minimum-region compensation unit to perform the anti-aliasing operation on pixels included in a corresponding region determined to be the minimum region, and a maximum-region compensation unit to perform the anti-aliasing operation on pixels included in a corresponding region determined to be the maximum region.

The minimum region compensation unit may compensate for pixel values of pixels included in the minimum region as a minimum value among pixel values of pixels included in the minimum region and pixel values of neighboring pixels adjacent to the minimum region.

The maximum-region compensation unit may compensate for pixel values of pixels included in the maximum region as a maximum value among the pixel values of the pixels included in the maximum region and pixel values of neighboring pixels adjacent to the maximum region, calculates first compensated pixel values, determines whether there are minimum regions in pixel regions neighboring the maximum region, and if the neighboring minimum regions exist, adds differences between original pixel values of the pixels included in the neighboring minimum regions and the first compensated pixel values of the pixels included in the neighboring minimum regions to the first compensated pixel values of the maximum region to calculate second compensated pixel values of the maximum region, and compensates for the pixel values of the pixels included in the maximum region according to the second compensated pixel values when the neighboring minimum regions are determined to exist.

The foregoing and/or other aspects of the present general inventive concept may also be achieved by providing an aliasing compensation device usable with an image interpolation apparatus, the device comprising an alias region detection unit to receive a plurality of color image signals having a plurality of corresponding high frequency components and to detect one or more regions from among a plurality of pixels of the color image signals where aliasing occurs according to a comparison of the high frequency components, and an aliasing processing unit to determine whether one or more pixels that corresponds to the one or more detected alias regions are one of a maximum value region and a minimum value region, to perform a first compensation operation when the one or more pixels that correspond to the one or more detected alias regions are determined to be the maximum value region, and to perform a second compensation operation when the one or more pixels that correspond to the one or more detected alias regions are determined to be the minimum value region.

The foregoing and/or other aspects of the present general inventive concept may also be achieved by providing an anti-aliasing unit usable with an image interpolation device, the unit comprising an alias region determination unit to determine whether a pixel of an alias region is one of a minimum value region with respect to neighboring pixels and a maximum value region with respect to the neighboring pixels, and a compensation unit to perform a compensation operation according to whether the pixel of the alias region is the minimum value region or the maximum value region and to restore an original image signal from an image signal having the alias region.

The foregoing and/or other aspects of the present general inventive concept may also be achieved by providing an image interpolation method, the method comprising interpolating an image captured by an image detector into an n²-times-density RGB image, and calculating high-frequency components R_{H}, G_{H}, and B_{H} and low-frequency components R_{L}, G_{L}, and B_{L} at pixels of respective R, G, and B images of the captured image, detecting an aliased region in the n²-times-density RGB image based on magnitudes and signs of the high-frequency components R_{H}, G_{H}, and B_{H} at the pixels of the n²-times-density RGB image, and performing an anti-aliasing operation on the detected aliased region and restoring an original image from the n²-times-density RGB image having the aliased region.

The detecting of the aliased region may include comparing the magnitudes of the high-frequency components R_{H}, G_{H}, and B_{H} at the pixels of the respective n²-times-density R, G, and B images, and determining a high-frequency component having a larger magnitude at a current pixel, setting a maximum region if the sign of the high-frequency component having the larger magnitude is positive (+) at the current pixel, setting a minimum region if the sign of the high-frequency component having the larger magnitude is negative (−) at the current pixel, and setting a zero region if the sign of the high-frequency component having the larger magnitude is zero at the current pixel, and determining that the maximum and minimum regions are aliased regions, and determining that the zero region is a region where aliasing has not occurred.

The performing of the anti-aliasing operation may include determining whether the detected aliased region is included in the minimum region or the maximum region, and compensating for pixel values of pixels included in the minimum region as a minimum value among pixel values of pixels included in the minimum region and pixel values of neighboring pixels adjacent to the minimum region, if it is determined that the aliased region is the minimum region.

The method may further comprise compensating for pixel values of pixels included in the maximum region as a maximum value among pixel values of pixels included in the maximum region and pixel values of neighboring pixels adjacent to the maximum region, and calculating first compensation pixel values, determining if there are minimum regions in pixel regions neighboring the maximum region, if the neighboring minimum regions are determined to exist, adding differences between original pixel values of pixels included in the neighboring minimum regions and the first compensated pixel values of the pixels included in the neighboring minimum regions to the first compensation pixel values of the maximum region to calculate second compensation pixel values of the maximum region, and compensating the pixel values of the pixels included in the maximum region as the calculated second compensation pixel values when the neighboring minimum values are determined to exist.

The foregoing and/or other aspects of the present general inventive concept may also be achieved by providing a method of compensating for aliasing usable with an image interpolation apparatus, the method comprising receiving a plurality of color image signals having a plurality of corresponding high frequency components, detecting one or more regions from among a plurality of pixels of the color image signals where aliasing occurs according to a comparison of the high frequency components, determining whether one or more pixels that correspond to the one or more detected alias regions are one of a maximum value region and a minimum value region, performing a first compensation operation when the one or more pixels that correspond to the one or more detected alias regions are determined to be the maximum value region, and performing a second compensation operation when the one or more pixels that correspond to the one or more detected alias regions are determined to be the minimum value region.

The foregoing and/or other aspects of the present general inventive concept may also be achieved by providing a method of compensating for aliasing in an image having a plurality of pixels, the method comprising receiving a plurality of image signals of the image having the plurality of pixels including maximum value regions and minimum value regions, and performing a compensation operation for each pixel of the maximum and minimum value regions. The compensation operation for each pixel includes: if the pixel is determined to correspond to a minimum value region, determining a first compensation value by adding a minimum value from among the pixel and at least two neighboring pixels to a value of the pixel, and if the pixel is determined to correspond to a maximum value region, determining a first compensation value by adding a maximum value from among the pixel and the at least two neighboring pixels to the value of the pixel, and if one of the at least two neighboring pixels is a minimum value region, determining a second compensation value by adding a difference of a first compensated value of the one neighboring pixel that corresponds to the minimum value region and an original pixel value of the one neighboring pixel that corresponds to the minimum value region to the first compensated pixel value of the pixel.

The foregoing and/or other aspects of the present general inventive concept may also be achieved by providing a computer readable medium containing executable code to perform an image interpolation method, the medium comprising a first executable code to interpolate an image captured by an image detector into an n²-times-density RGB image, and calculating high-frequency components R_{H}, G_{H}, and B_{H} and low-frequency components R_{L}, G_{L}, and B_{L} at pixels of respective R, G, and B images of the captured image, a second executable code to detect an aliased region in the n²-times-density RGB image based on magnitudes and signs of the high-frequency components R_{H}, G_{H}, and B_{H} at the pixels of the n²-times-density RGB image, and a third executable code to perform an anti-aliasing operation on the detected aliased region and restoring an original image from the n²-times-density RGB image having the aliased region.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a view schematically illustrating a conventional 3-CCD pixel optical converter;

FIG. 2 is a view illustrating pixel locations of red and blue CCDs and pixel locations of a green CCD;

FIG. 3 is a block diagram illustrating a structure of an image interpolation device according to an embodiment of the general inventive concept;

FIG. 4 is a view illustrating an image signal of an object and pixels on 3-CCD screens;

FIG. 5 is a view illustrating images captured by respective CCDs when an image signal of an object is the same as the image signal of FIG. 4;

FIG. 6 is a flowchart illustrating an image interpolation method according to an embodiment of the general inventive concept;

FIG. 7A is a view illustrating waveforms of low-frequency components of an RGB image calculated by an n²-times-density image interpolation part of the image interpolation device of FIG. 3 according to an embodiment of the present general inventive concept;

FIG. 7B is a view illustrating waveforms of high-frequency components of an RGB image calculated by an n²-times-density image interpolation part of the image interpolation device of FIG. 3 according to an embodiment of the present general inventive concept;

FIG. 8 is a flowchart illustrating an operation S640 of the image interpolation method of FIG. 6 in detail;

FIG. 9 is a flowchart illustrating an operation S660 of the image interpolation method of FIG. 6 in detail;

FIG. 10 is a view illustrating a process to perform compensation for pixel values of the high-frequency components of the RGB image illustrated in FIG. 7B; and

FIG. 11 is a view illustrating image waveforms output as a result of performing an anti-aliasing operation according to an embodiment of the general inventive concept.

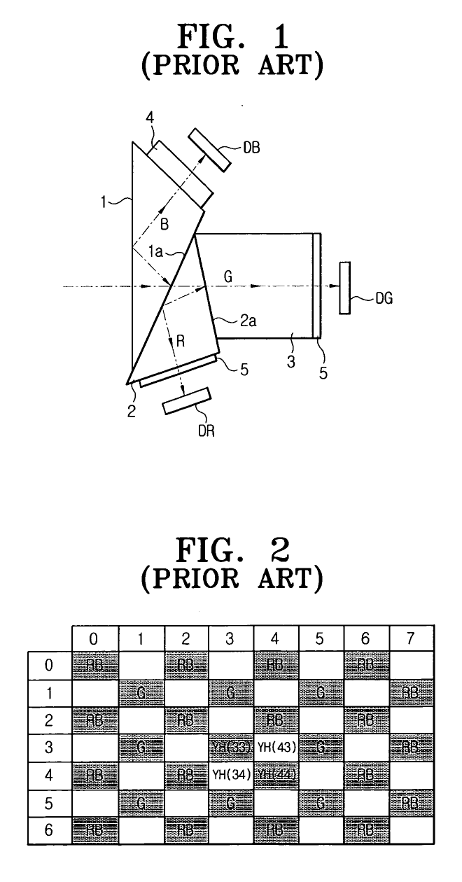

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

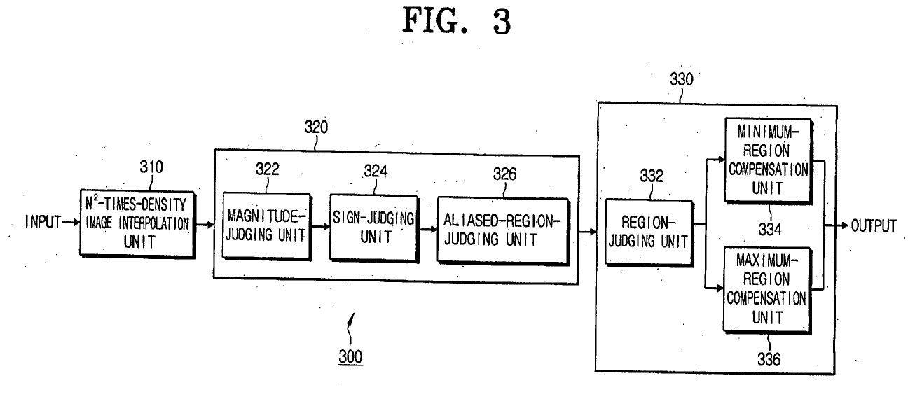

FIG. 3 is a block diagram illustrating a structure of an image interpolation device 300 according to an embodiment of the general inventive concept. As illustrated in FIG. 3, the image interpolation device 300 comprises an n²-times-density image interpolation part 310, an aliased-region detection part 320, and an anti-aliasing-processing part 330.

The n²-times-density image interpolation part 310 interpolates an image captured by an image detector such as a CCD, and calculates high-frequency components R_{H}, G_{H}, and B_{H} and low-frequency components R_{L}, G_{L}, and B_{L} of respective R, G, and B images (n²-times-density RGB images). The n²-times-density image interpolation part 310 performs an interpolation method based on neighboring pixel data in respective CCDs and calculates R, G, and B data of the R, G, and B images, regardless of correlations of different CCDs. The image interpolation method performed by the n²-times-density image interpolation part 310 can be any image interpolation method, such as linear, bilinear, cubic, and poly-phase methods.

The aliased-region detection part 320 detects an aliased region where aliasing occurs, based on magnitudes and signs of the high-frequency components R_{H}, G_{H}, and B_{H} of the n²-times-density RGB images received from the n²-times-density image interpolation part 310.

The aliased-region detection part 320 includes a magnitude-judging unit 322, a sign-judging unit 324, and an aliased-region-judging unit 326. The magnitude-judging unit 322 compares the magnitudes (i.e., amplitude magnitudes) of the high-frequency components R_{H}, G_{H}, and B_{H} at pixels of the respective n²-times-density R, G, and B images received from the n²-times-density image interpolation part 310, and determines (i.e., judges) a high-frequency component having a larger magnitude. That is, the magnitude-judging unit 322 compares the high frequency components R_{H}, G_{H}, and B_{H} for the respective image signals R, G, and B over a plurality of pixels to determine whether aliasing occurs. The high-frequency components R_{H} and B_{H} for the respective image signals R and B over the plurality of pixels may be the same. In this case, the magnitude-judging unit 322 compares the high-frequency components R_{H} and B_{H} of the image signals R and B with the high frequency component G_{H} of the image signal G. The sign-judging unit 324 determines (i.e., judges) a sign of the high-frequency component having the larger magnitude for each pixel. If the sign of the high-frequency component having the larger magnitude is positive (+), the sign-judging unit 324 sets a corresponding region (i.e., the region including a current pixel of the image signal RGB) as a maximum region. If the sign of the high-frequency component having the larger magnitude is negative (−), the sign-judging unit 324 sets the corresponding region as a minimum region, and if the high-frequency component having the larger magnitude is zero, the sign-judging unit 324 sets the corresponding region as a zero region. The aliased-region-judging unit 326 determines that the maximum and minimum regions are aliased regions where aliasing is determined to have occurred, and determines that the zero region is a non-aliased region where aliasing is determined not to have occurred.

The anti-aliasing-processing part 330 applies an anti-aliasing operation to the aliased region detected by the aliased-region detection part 320, and restores an original image from an aliased image. In other words, the magnitude judging unit 322 determines the high frequency component having the larger magnitude in order to determine whether aliasing occurs in the corresponding region including the current pixel. The aliased-region judging unit 326 determines that the aliasing occurs in the corresponding region of the current pixel when the sign of the high frequency component having the larger magnitude is non-zero.

The anti-aliasing-processing part 330 includes a region-judging unit 332, a minimum-region compensation unit 334, and a maximum-region compensation unit 336. The region-judging unit 332 determines (i.e., judges) whether the detected aliased region is the minimum region or the maximum region. The minimum-region compensation unit 334 compensates for pixel values included in both the minimum region as a minimum value among pixel values of pixels of the minimum region and pixel values of neighboring pixels adjacent to the minimum region, and performs the anti-aliasing operation in accordance with the determination that the corresponding region including the current pixel is the minimum region. The maximum-region compensation unit 336 compensates for pixel values using two operations. In a first operation, the maximum-region compensation unit 336 compensates for pixel values included in the maximum region as a maximum value among pixel values of pixels included in both the maximum region and pixel values of neighboring pixels adjacent to the maximum region. In a second operation, the maximum-region compensation unit 336 determines whether there are minimum regions in pixel regions neighboring the maximum region (i.e., neighboring minimum regions). If the maximum-region compensation unit 336 determines that there are neighboring minimum regions with respect to the maximum region, the maximum-region compensation unit 336 adds differences between original pixel values of the pixels included in the neighboring minimum regions and the compensated pixel values of the pixels included in the neighboring minimum regions to the compensated pixel values of the first operation. The maximum-region compensation unit 336 then performs the anti-aliasing operation.

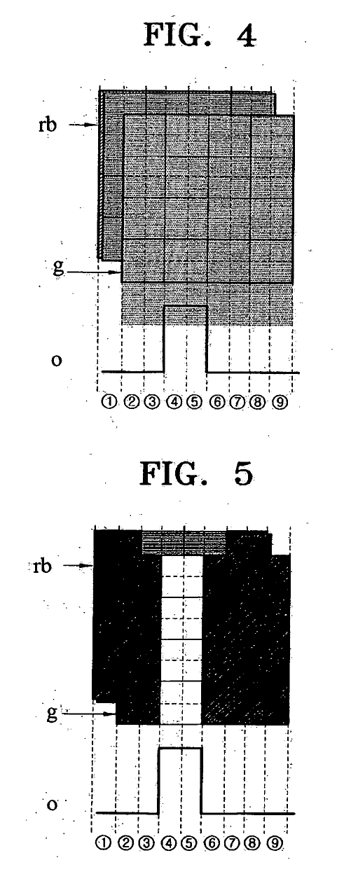

FIG. 4 is a view illustrating an image signal of an object and pixels on 3-CCD screens. In FIG. 4, reference numerals \textcircled{1} to \textcircled{9} represent a double-density image, i.e., numbers of pixels grouped horizontally. In addition, a reference numeral “rb” represents pixels on a red CCD screen and pixels on a blue CCD screen, a reference numeral “g” represents pixels on a green CCD screen, and a reference numeral “o” represents (the Object Image Signal of a subject) an image signal of an object. As illustrated in FIG. 4, the pixels “g” on the green CCD screen are each shifted by 1/n pixel from the pixels “rb” on the red and blue CCD screens. In the present embodiment, n=2.

FIG. 5 is a view illustrating images captured by the respective CCDs having the image signal “o” of the object illustrated in FIG. 4. Referring to FIG. 5, the image is formed with the pixels “rb” on the red and blue CCD screens, and with the pixels “g” on the green CCD screen. The image is formed over every two pixels of the pixels “rb” on the red and blue CCD screens, since the image signal “o” of the object has a frequency that is higher than a sampling frequency, so that a signal having a low amplitude is output. The image is formed over every one pixel of the pixels “g” on the green CCD screen, so that a signal having a high amplitude is output.

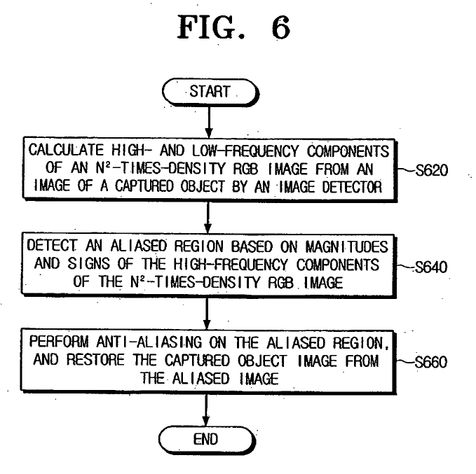

FIG. 6 is a flow chart illustrating an image interpolation method according to an embodiment of the present general inventive concept. Referring to FIGS. 3 to 6, the n²-times-density image interpolation part 310 first calculates the high-frequency components R_{H}, G_{H}, and B_{H} and the low-frequency components R_{L}, G_{L}, and B_{L} of an n²-times-density image (i.e., the R, G, and B images) from an image of an object captured by an image-capturing device (e.g., the CCDs) (operation S620).

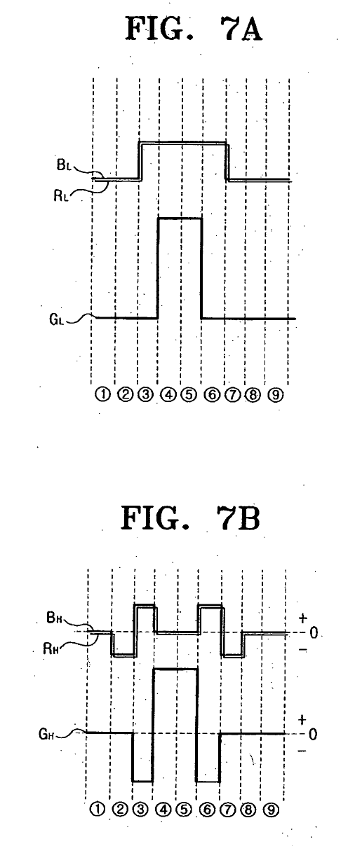

That is, the n²-times-density image interpolation part 310 inputs an image as illustrated in FIG. 5 from the respective CCDs, applies a general image interpolation method, and calculates the high-frequency components R_{H}, G_{H}, and B_{H} and the low-frequency components R_{L}, G_{L}, and B_{L} of the respective R, G, and B images. In the present embodiment, it can be assumed that n²=4. FIG. 7A is a view illustrating waveforms of the low-frequency components R_{L}, G_{L}, and B_{L} of the RGB image that are calculated by the n²-times-density image interpolation part 310, and FIG. 7B is a view illustrating waveforms of the high-frequency components R_{H}, G_{H}, and B_{H} of the RGB image that are calculated by the n²-times-density image interpolation part 310. As illustrated in FIGS. 7A and 7B, the magnitudes of the image signals R and B are the same, but the magnitudes of the image signal G is substantially different from the image signals R and B.

The aliased-region detection part 320 detects the region where aliasing has occurred, based on the magnitudes and the signs of the high-frequency components R_{H}, G_{H}, and B_{H} of the n²-times-density RGB image received from the n²-times-density image interpolation part 310 (operation S640). That is, the aliased-region detection part 320 analyzes the high-frequency components R_{H}, G_{H}, and B_{H} of a double-density image in the horizontal and the vertical directions, respectively, i.e. a four-times-density RGB image (n=2), and determines whether each of the pixels of the double-density image are a zero region, a minimum region, and a maximum region.

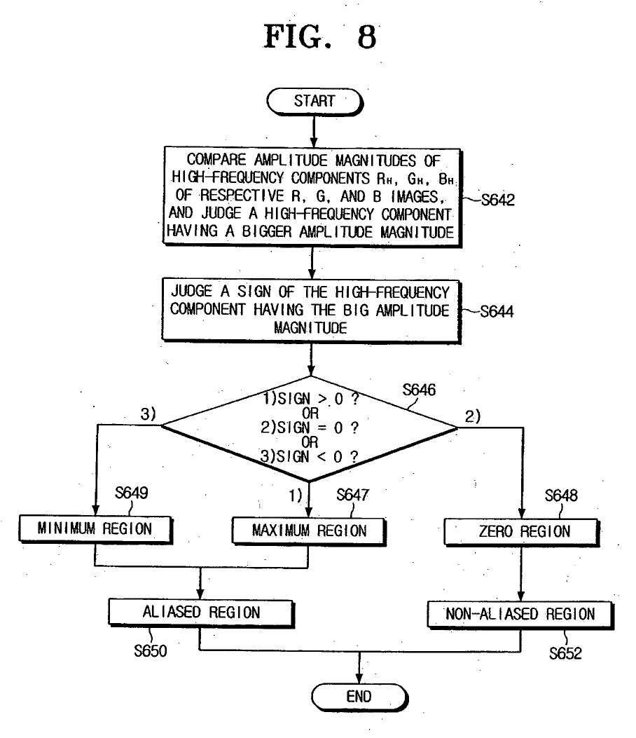

FIG. 8 is a flowchart illustrating the operation S640 of FIG. 6 in detail. Hereinafter, a description of the double-density image in the horizontal direction will be provided. However, it should be understood that the method of the present embodiment may also be performed in the vertical direction of the double-density image. Referring to FIG. 8, the magnitude-judging unit 322 of the aliased-region detection part 320 compares the magnitudes (i.e., amplitude magnitudes) of the high-frequency components R_{H}, G_{H}, and B_{H} of the n²-times-density RGB image illustrated in FIG. 7B, and determines the high-frequency component having the larger magnitude (operation S642). The magnitude-judging unit 322 may perform this operation for a plurality of pixels (e.g., \textcircled{1} through \textcircled{9} in FIG. 7B). For example, the magnitude-judging unit 322 may perform the operation 642 of the method of FIG. 6 individually on a current pixel of the double-density image for all the pixels thereof.

When the high-frequency component having the larger magnitude is determined, the sign-judging unit 324 determines the sign of the high-frequency component having the larger magnitude at a plurality of or the current pixel (operation S644). As a result of the determination, if the sign of the high-frequency component having the larger magnitude is positive (+) (operation S646), the corresponding region is set to a maximum region (operation S647). If the sign of the high-frequency component having the larger magnitude is negative (−) (operation S646), the corresponding region is set to a minimum region (operation S649), and if the sign of the high-frequency component having the larger magnitude is zero, the corresponding region (i.e., that corresponds to the current pixel of the image signal RGB) is set to a zero region (operation S648). In other words, the zero region indicates that the signal of the high frequency component having the larger magnitude is zero.

The aliased-region-judging unit 326 determines that the maximum and minimum regions are regions where aliasing has occurred (operation S650), and determines that the zero region is a region where aliasing has not occurred (operation S652).

Absolute values of the magnitudes (amplitudes) of the high-frequency components of R, G, and B image signals R_{H}, B_{H}, and G_{H} may be compared. As illustrated in FIG. 7B, all of the respective image signals (i.e., R, G, and B) for the pixels (\textcircled{1}, \textcircled{8}, and \textcircled{9} have high-frequency components of zero, the high-frequency components R_{H} and B_{H} of the respective image signals R and B for the pixels \textcircled{2} and \textcircled{7} have absolute values of the magnitude larger than zero, and the high-frequency component G_{H} of the respective image signal G for the pixels \textcircled{3}, \textcircled{4}, \textcircled{5}, and \textcircled{6} has an absolute value of the magnitude that is larger than zero. If all of the respective R, G, and B image signals have high-frequency components of zero at the current pixel, the corresponding region is set to a zero region. If the sign of the image signal having the largest absolute value of the magnitude is negative (−) at the current pixel, the corresponding region is set to a minimum region. If the sign of the image signal having the largest absolute value of the magnitude is positive (+) at the current pixel, the corresponding region of the current pixel is set to a maximum region. That is, as illustrated in FIG. 7B, the zero regions are set for pixels \textcircled{1}, \textcircled{8}, and \textcircled{9}, the minimum region is set for the pixels \textcircled{2}, \textcircled{3}, \textcircled{6}, and \textcircled{7}, the maximum region is set for pixels \textcircled{4} and \textcircled{5}, respectively. This can be expressed in Equation 1 as below.

[Equation 1]

D=Max(Abs(B_{H}&R_{H}), Abs(G_{H}));
if (D==Abs(B_{H}&R_{H}))
{

if (B_{H}&R_{H} < 0)

Range = Minimum;

if (B_{H}&R_{H} > 0)

Range = Maximum;

else if ((B_{H}&R_{H} > 0)

Range = Zero;

}
if (D==Abs(G_{H}))
{

if (G_{H}<0)

Range = Minimum;

else if (G_{H}>0)

Range = Maximum;

else

Range = Zero;

}

Equation 1, Max( ) represents a function to calculate a maximum value, and Abs( ) a function to calculate an absolute value.

In the operation S640, if an aliased-region is detected, the anti-aliasing-processing part 330 applies the anti-aliasing operation to the detected aliased-region, and restores the original image from the image containing the aliased-region (operation S660).

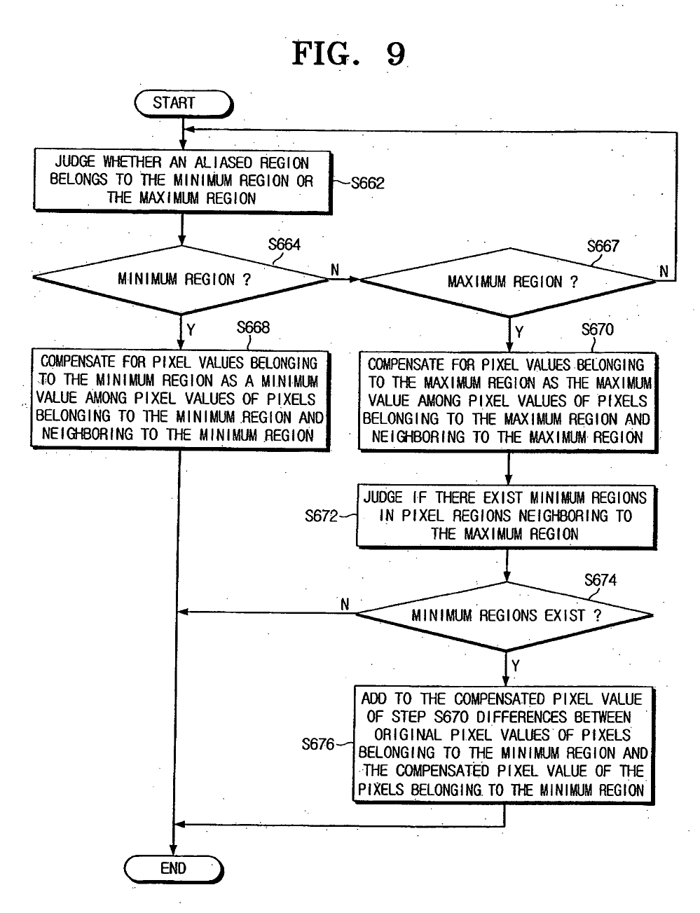

FIG. 9 is a flowchart illustrating the operation S660 of the image interpolation method of FIG. 6 in detail. Referring to FIGS. 3 to 9, the region-judging unit 332 determines (judges) whether the detected aliased-region is included in a minimum region or a maximum region (operation S662).

That is, as a result of the determination of the region judging unit 332 in the operation S662, if the aliased-region is included in the minimum region (operation S666), the minimum-region compensation unit 334 compensates for pixel values included in the minimum region as the minimum value among the values of the pixels included in both the minimum region and pixel values of neighboring pixels adjacent to the minimum region (operation S668), and performs the anti-aliasing operation. The minimum value is an absolute value having the smallest value.

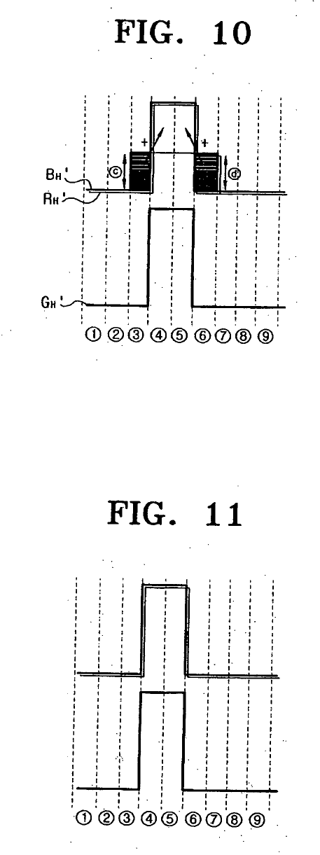

FIG. 10 is a view illustrating a process to compensate for pixel values over the high-frequency components of the RGB image illustrated in FIG. 7B. Referring to FIGS. 3 to 10, if the anti-aliasing operation is performed over the pixel \textcircled{2} of the R_{H} and B_{H} determined as the minimum region in FIG. 7B, the pixel value \textcircled{2} of the R_{H} and B_{H} is compensated with the value of the pixel \textcircled{3} that is the minimum value of the pixels \textcircled{1}, \textcircled{2}, and \textcircled{3}. In other words, the compensated pixel value of pixel \textcircled{2} of the high frequency components R_{H} and B_{H} of the image signals R and B is set to a sum of an original pixel value of pixel \textcircled{2} and an original pixel value of pixel \textcircled{3}, since pixel \textcircled{3} is the minimum value of the pixels \textcircled{1}, \textcircled{2}, and \textcircled{3}.

On the other hand, if the aliased-region is included in the maximum region (operation S667), the maximum-region compensation unit 336 compensates for the pixel values included in the maximum region as the pixel values having the maximum value among the pixel values of the pixels included in the maximum region and pixel values of neighboring pixels adjacent to the maximum region (operation S670).

Then, the maximum-region compensation unit 336 determines whether (judges) there are minimum regions in pixel regions neighboring the maximum region (i.e., neighboring minimum regions) (operation S672). As a result of the determination of the maximum-region compensation unit 336, if the neighboring minimum regions exist (operation S674), the maximum-region compensation unit 336 performs the anti-aliasing operation by adding differences between the original pixel values of pixels included in the neighboring minimum region and the compensated pixel values of the pixels included in the neighboring minimum region to the compensated pixel values of the maximum region of the operation S670 (S676).

Referring to FIG. 10, if the anti-aliasing operation is performed on the pixel \textcircled{4} of the R_{H} and B_{H} illustrated in FIG. 7B, the maximum value among the pixels \textcircled{3}, \textcircled{4}, and \textcircled{5} of data is used for compensations for the pixel value of the pixel \textcircled{4}. That is, since an original pixel value of pixel \textcircled{3} of the high frequency components R_{H} and B_{H} is the maximum value among the pixels \textcircled{3}, \textcircled{4} (i.e., the pixel being compensated), and \textcircled{5}, a compensation pixel value of pixel \textcircled{4} is determined to be a sum of the original pixel values of pixel \textcircled{3} and pixel \textcircled{5}. Then, since a minimum region exists at the pixel \textcircled{3} among the pixels \textcircled{3}, \textcircled{4}, and \textcircled{5}, differences “c” between the original pixel value of the pixel \textcircled{3} of and the compensated pixel value of the pixel \textcircled{3} are added to the compensated pixel value \textcircled{4}.

FIG. 11 is a view illustrating image waveforms output as a result of performing the anti-aliasing operation according to an embodiment of the present general inventive concept. Referring to FIG. 11, in the same manner described above, the image including the aliased-region is restored to the original image, so that an image having high-frequency components can be enhanced without overshoots and undershoots occurring.

The present general inventive concept may be embodied in hardware, software, or a combination thereof. For example, the present general inventive concept may be embodied by a computer running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code to cause a number of computer systems connected via a network to effect distributed processing.

As described above, the various embodiments of the present general inventive concept can restore an image signal distorted by aliasing to be identical to an original image signal of an object. Therefore, the various embodiments of the present general inventive concept have an advantage of enhancing high-frequency components of the image signal without overshoots and undershoots occurring, thereby reducing color errors and enhancing an image contrast. In addition, the image interpolation devices described above can be used with a projection apparatus, for example, an image projector having a 3-CCD pixel converter of R, G, and B CCDs to generate R, G and B images and/or prisms to receive the RGB images from the 3-CCD pixel converter so that the RGB images are enlarged and projected onto a screen.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image interpolation device, comprising:
an aliased-region detection part to detect a region in which aliasing has occurred based on magnitudes and signs of high-frequency components R_{H}, G_{H}, and B_{H} at pixels of n²-times-density R, G, and B images; and
an anti-aliasing-processing part to perform an anti-aliasing operation on the detected aliased-region and to restore an original image from the aliased image.

2. The device as claimed in claim 1, further comprising:
an n²-times-density image interpolation part to interpolate an image captured by an image detector into the n²-times-density images and to calculate the high-frequency components R_{H}, G_{H}, and B_{H} and low-frequency components R_{L}, G_{L}, and B_{L} of the corresponding R, G, and B images, respectively.

3. The device as claimed in claim 1, wherein the aliased-region detection part comprises:
a magnitude-judging unit to compare magnitudes of the high-frequency components R_{H}, G_{H}, and B_{H} at the pixels of the respective n²-times-density R, G, and B images and to determine a high-frequency component having a larger magnitude at a current pixel;
a sign-judging unit to set a maximum region if a sign of the high-frequency component having the larger magnitude among the high-frequency components R_{H}, G_{H}, and B_{H} at the current pixel of the n²-times-density RGB image is positive (+), to set a minimum region if the sign of the high-frequency component having the larger magnitude among the high-frequency components R_{H}, G_{H}, and B_{H} at the current pixel of the n²-times-density RGB image is negative (−), and to set a zero region if the sign of the high-frequency component having the larger magnitude among the high-frequency components R_{H}, G_{H}, and B_{H} at the current pixel of the n²-times-density RGB image is zero; and
an aliased-region-judging unit to determine that the maximum and minimum regions are regions where aliasing has occurred and to determine that the zero region is a region where aliasing has not occurred.

4. The device as claimed in claim 3, wherein the magnitude-judging unit compares the magnitudes of the high frequency components R_{H} and B_{H} of respective image signals R and B with the magnitude of the high frequency components G_{H} of image signal at the current pixel.

5. The device as claimed in claim 3, wherein the anti-aliasing-processing part comprises:
a region-judging unit to determine whether the detected aliased-region is included in the minimum region or the maximum region;
a minimum-region compensation unit to perform the anti-aliasing operation on pixels included in a corresponding region determined to be the minimum region; and
a maximum-region compensation unit to perform the anti-aliasing operation on pixels included in a corresponding region determined to be the maximum region.

6. The device as claimed in claim 5, wherein the minimum region compensation unit compensates for pixel values of pixels included in the minimum region as a minimum value among pixel values of pixels included in the minimum region and pixel values of neighboring pixels adjacent to the minimum region.

7. The device as claimed in claim 5, wherein the maximum-region compensation unit compensates for pixel values of pixels included in the maximum region as a maximum value among the pixel values of the pixels included in the maximum region and pixel values of neighboring pixels adjacent to the maximum region, calculates first compensated pixel values of the maximum region, determines whether there are minimum regions in pixel regions neighboring the maximum region, and if the neighboring minimum regions exist, adds differences between original pixel values of the pixels included in the neighboring minimum regions and the compensated pixel values of the pixels included in the neighboring minimum regions to the first compensated pixel values of the maximum region to calculate second compensated pixel values, and compensates for the pixel values of the pixels included in the maximum region according to the second compensated pixel values when the neighboring minimum values are determined to exist.

8. The image interpolation device as claimed in claim 1, wherein the aliased-region detection part detects aliased regions in a vertical direction and a horizontal direction of the images pixel for each pixel.

9. An aliasing compensation device usable with an image interpolation apparatus, the device comprising:
an alias region detection unit to receive a plurality of color image signals having a plurality of corresponding high frequency components and to detect one or more regions from among a plurality of pixels of the color image signals where aliasing occurs according to a comparison of the high frequency components; and
an aliasing processing unit to determine whether one or more pixels that correspond to the one or more detected alias regions are one of a maximum value region and a minimum value region, to perform a first compensation operation when the one or more pixels that correspond to the one or more detected alias regions are determined to be the maximum value region, and to perform a second compensation operation when the one or more pixels that correspond to the one or more detected alias regions are determined to be the minimum value region.

10. The compensation device as claimed in claim 9, wherein the alias region detection unit detects the one or more alias regions by determining whether the high frequency components of the color image signals have non-zero magnitudes at the plurality of pixels.

11. The compensation device as claimed in claim 9, wherein the first compensation operation comprises a minimum compensation operation in which the alias processing unit determines one or more first compensation values for values of each of the one or more pixels determined to correspond to the minimum value region according to original values of each of the one or more pixels and neighboring pixel values.

12. The compensation device as claimed in claim 9, wherein the second compensation operation comprises a maximum compensation operation in which the alias processing unit determines one or more first compensation values for values of each of the one or more pixels determined to correspond to the maximum value region according to original values of each of the one or more pixels and neighboring pixel values, determines whether any of the neighboring pixels correspond to minimum value regions, and if any of the neighboring pixels correspond to the minimum value regions determines a difference between original pixel values of the neighboring pixels that correspond to the minimum value regions and first compensation values of the neighboring pixels that correspond to the minimum value regions and adding the determined difference to the first compensated pixel values of the maximum value region.

13. An anti-aliasing unit usable with an image interpolation device, the unit comprising:
an alias region determination unit to determine whether a pixel of an alias region is one of a minimum value region with respect to neighboring pixels and a maximum value region with respect to the neighboring pixels; and
a compensation unit to perform a compensation operation according to whether the pixel of the alias region is the minimum value region or the maximum value region and to restore an original image signal from an image signal having the alias region.

14. The anti-aliasing unit as claimed in claim 13, wherein the compensation unit comprises
a minimum region compensation unit to compensate the pixel of the alias region, when the pixel is determined to be the minimum value region according to original value of the pixel and original values of neighboring pixels; and
a maximum region compensation unit to compensate the pixel of the alias region, when the pixel is determined to be the maximum value region according to the original value of the pixel and the original values of neighboring pixels when the neighboring pixels are not minimum value regions, and to compensate the pixel according to the original value of the pixel, the original values of the neighboring pixels, and compensated values of the neighboring pixels when at least one of the neighboring pixels is a minimum value region.

15. An image interpolation method, the method comprising:
interpolating an image captured by an image detector into an n²-times-density RGB image, and calculating high-frequency components R_{H}, G_{H}, and B_{H} and low-frequency components R_{L}, G_{L}, and B_{L} at pixels of respective R, G, and B images of the captured image;
detecting an aliased region in the n²-times-density RGB image based on magnitudes and signs of the high-frequency components R_{H}, G_{H}, and B_{H} at the pixels of the n²-times-density RGB image; and
performing an anti-aliasing operation on the detected aliased region and restoring an original image from the n²-times-density RGB image having the aliased region.

16. The method as claimed in claim 15, wherein the detecting of the aliased-region detection comprises:
comparing the magnitudes of the high-frequency components R_{H}, G_{H}, and B_{H} at the pixels of respective n²-times-density R, G, and B images, and determining a high-frequency component having a larger magnitude at a current pixel;
setting a maximum region if the sign of the high-frequency component having the larger magnitude is positive (+) at the current pixel, setting a minimum region if the sign of the high-frequency component having the larger magnitude is negative (−) at the current pixel, and setting a zero region if the sign of the high-frequency component having the larger magnitude is zero at the current pixel; and
determining that the maximum and minimum regions are aliased regions, and determining that the zero region is a region where aliasing has not occurred.

17. The method as claimed in claim 16, wherein the performing of the anti-aliasing operation comprises:
determining whether the detected aliased region is included in the minimum region or the maximum region; and
compensating for pixel values of pixels included in the minimum region as a minimum value among pixel values of pixels included in the minimum region and pixel values of neighboring pixels adjacent to the minimum region, if it is determined that the aliased region is the minimum region.

18. The method as claimed in claim 17, wherein the performing of the anti-aliasing operation further comprises:
if the aliased region is determined to be the maximum region, compensating for pixel values of pixels included in the maximum region as a maximum value among pixel values of pixels included in the maximum region and pixel values of neighboring pixels adjacent to the maximum region, and calculating first compensation pixel values of the maximum region;
determining if there are minimum regions in pixel regions neighboring the maximum region;
if the neighboring minimum regions are determined to exist, adding differences between original pixel values of pixels included in the neighboring minimum regions and the first compensated pixel values of the pixels included in the neighboring minimum regions to the first compensated pixel values of the maximum region to calculate second compensation pixel values of the maximum region; and
compensating the pixel values of the pixels included in the maximum region as the calculated second compensation pixel values when the neighboring minimum values are determined to exist.

19. A method of compensating for aliasing usable with an image interpolation apparatus, the method comprising:
receiving a plurality of color image signals having a plurality of corresponding high frequency components;
detecting one or more regions from among a plurality of pixels of the color image signals where aliasing occurs according to a comparison of the high frequency components;
determining whether one or more pixels that correspond to the one or more detected alias regions are one of a maximum value region and a minimum value region;
performing a first compensation operation when the one or more pixels that correspond to the one or more detected alias regions are determined to be the maximum value region; and
performing a second compensation operation when the one or more pixels that correspond to the one or more detected alias regions are determined to be the minimum value region.

20. A method of compensating for aliasing in an image having a plurality of pixels, the method comprising:
receiving a plurality of image signals of the image having the plurality of pixels including maximum value regions and minimum value regions; and
for each pixel in the minimum and maximum regions, performing a compensation operation including:
if the pixel is determined to correspond to a minimum value region, determining a first compensation value by adding a minimum value from among the pixel and at least two neighboring pixels to a value of the pixel, and
if the pixel is determined to correspond to a maximum value region, determining a first compensation value by adding a maximum value from among the pixel and the at least two neighboring pixels to the value of the pixel, and if one of the at least two neighboring pixels is a minimum value region, determining a second compensation value by adding a difference of a first compensated value of the one neighboring pixel that corresponds to the minimum value region and an original pixel value of the one neighboring pixel that corresponds to the minimum value region to the first compensated pixel value of the pixel.

21. A computer readable medium containing executable code to perform an image interpolation method, the medium comprising:
a first executable code to interpolate an image captured by an image detector into an n²-times-density RGB image, and calculating high-frequency components R_{H}, G_{H}, and B_{H} and low-frequency components R_{L}, G_{L}, and B_{L} at pixels of respective R, G, and B images of the captured image;
a second executable code to detect an aliased region in the n²-times-density RGB image based on magnitudes and signs of the high-frequency components R_{H}, G_{H}, and B_{H} at the pixels of the n²-times-density RGB image; and
a third executable code to perform an anti-aliasing operation on the detected aliased region and restoring an original image from the n²-times-density RGB image having the aliased region.
